(19) United States
(12) Patent Application Publication
(10) Pub. No.: US 2026/0109133 A1
(43) Pub. Date: Apr. 23, 2026

(54) COMPOSITE TITANIUM COOKWARE

(71) Applicant: TIMAS TITAN CO., LTD., Taipei City (TW)

(72) Inventors: Han-Chun Hsieh, Taipei City (TW); Han-Chieh Hsieh, Taipei City (TW)

(21) Appl. No.: 19/358,387

(22) Filed: Oct. 14, 2025

(30) Foreign Application Priority Data
Oct. 23, 2024 (TW) 113140233

(51) Int. Cl. B32B 15/01; B32B 7/022

(52) U.S. Cl. CPC B32B 15/012; B32B 7/022; B32B 2250/05; B32B 2255/06; B32B 2255/20; B32B 2307/208

(57) ABSTRACT

A composite titanium cookware. The composite titanium cookware includes a multi-layered cookware body, the multi-layered cookware body includes a titanium layer arranged at an inner surface of the multi-layered cookware body, a stainless steel layer arranged at an outer side of the multi-layered cookware body, and an aluminum alloy sandwich structure arranged between the titanium layer and the stainless steel layer. The titanium layer and the stainless steel layer are combined at two sides of the aluminum alloy sandwich structure in an atomic diffusion bonding manner.

### CROSS-REFERENCE TO RELATED PATENT APPLICATION

This application claims the benefit of priority to Taiwan Patent Application No. 113140233, filed on Oct. 23, 2024. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a titanium cookware, and more particularly to a composite titanium cookware.

### BACKGROUND OF THE DISCLOSURE

In pursuit of health, modern people use cookware for preparing food or tableware for holding food that are non-toxic and zero-pollution. Since titanium has properties of being light-weight, high-temperature resistant, corrosion resistant, and having low thermal conductivity, more and more cookware are made of titanium.

Since the physical properties of titanium include being low weight and high strength, titanium cookware also has an advantage of being low weight. However, since a thermal conductivity of titanium is close to that of steel, titanium has a low specific heat capacity, and accordingly, titanium has the characteristic of fast heat dissipation. In addition, since titanium tableware is mostly made of titanium plates, and titanium cannot store heat, such that a temperature of a portion of the titanium cookware that is in contact with a heating source easily increases, a temperature a portion of the titanium cookware that is not in contact with the heating source can easily decrease. Heat is concentrated at the portion of the titanium cookware that is in contact with the heating source, and the heat at the portion that is not in contact with the heating source is insufficient. Accordingly, food that is in contact with the heat concentrated portion of the titanium cookware is prone to overheating and burning, and food that is in contact with the low temperature portion of the titanium cookware are easily undercooked or even not cooked at all.

In the existing techniques, in some titanium cookware, the titanium cookware is combined on a heat-conducting metal layer, and the titanium cookware is evenly heated through the heat conduction of the heat-conducting metal layer. However, in the conventional titanium cookware, the titanium board and the heat-conducting metal layer is usually combined in a hard soldering manner or a soft soldering manner, thereby easily causing the problem of poor welding. In addition, since titanium and conductive metal have different expansion coefficients, after long-term use, the titanium layer is easy to peel off from the heat-conducting metal layer, resulting in reduced thermal conductivity of the cookware.

According to the above reasons, the conventional titanium cookware is quite inconvenient to use and difficult to manufacture. Therefore, how to overcome the above-mentioned problems through improvements in structural design has become one of the important issues to be solved in the relevant field.

### SUMMARY OF THE DISCLOSURE

In response to the above-referenced technical inadequacy, the present disclosure provides a composite titanium cookware to overcome the problems in the existing techniques.

In order to solve the above-mentioned problems, one of the technical aspects adopted by the present disclosure is to provide a composite titanium cookware. The composite titanium cookware includes a multi-layered cookware body including a titanium layer arranged at an inner surface of the multi-layered cookware body, a stainless steel layer arranged at an outer surface of the multi-layered cookware body, and an aluminum alloy sandwich structure arranged between the titanium layer and the stainless steel layer. The aluminum alloy sandwich structure includes a first aluminum alloy material layer and two second aluminum alloy material layers arranged at two opposite side surfaces of the first aluminum alloy material layer. A tensile strength of the first aluminum alloy material layer is greater than a tensile strength of each of the second aluminum alloy material layers. The first aluminum alloy material layer and the second aluminum alloy material layers are combined in an atomic diffusion bonding manner. After the first aluminum alloy material layer and the second aluminum alloy material layers of the aluminum alloy sandwich structure are combined in the atomic diffusion bonding manner, the titanium layer and the stainless steel layer are combined with two side surfaces of the aluminum alloy sandwich structure through the atomic diffusion bonding manner. After the aluminum alloy sandwich structure, the titanium layer, and the stainless steel layer are combined to form a multi-layered composite material that is in a flat shape, the multi-layered composite material forms into the composite titanium cookware in a plastic processing manner.

Therefore, in the present disclosure, the aluminum alloy sandwich structure is disposed between the titanium layer and the stainless steel layer, the titanium layer and the stainless steel layer are combined with the aluminum alloy sandwich structure through diffusion, so as to overcome the difficulty of combining titanium and stainless steel in a conventional method for producing a cookware. In addition, since each metal layer of the multi-layered cookware body is combined in the atomic diffusion bonding manner, each metal layer can easily peel off, and the multi-layered cookware body has a strength that is on par with a cookware that is integrally-formed by a metal board.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a schematic assembled side view according to a first embodiment of the present disclosure;

FIG. 2 is a schematic partial enlarged view of area II in FIG. 2;

FIG. 3 is a schematic view showing a first aluminum alloy material layer and a second aluminum alloy material layer of an aluminum alloy sandwich structure that are not assembled according to the present disclosure;

FIG. 4 is a schematic view showing an operation manner of combining the first aluminum alloy material layer and the second aluminum alloy material layer into the aluminum alloy sandwich structure through a first diffusion bonding process according to an embodiment of the present disclosure;

FIG. 5 is a schematic view showing a titanium layer, a stainless steel layer, and the aluminum alloy sandwich structure that are not assembled according to the present disclosure;

FIG. 6 is a schematic view showing an operation manner of combining the titanium layer, the stainless steel layer, and the aluminum alloy sandwich structure into a multi-layered composite material for producing a multi-layered cookware body through a second diffusion bonding process according to one embodiment of the present disclosure;

FIG. 7 is a schematic operation view of a cookware forming process according to one embodiment of the present disclosure;

FIG. 8 is a schematic operation view of a trimming process according to one embodiment of the present disclosure;

FIG. 9 is a schematic view of a composite titanium cookware according to one embodiment of the present disclosure; and

FIG. 10 is a flowchart of a method for producing a composite titanium cookware according to the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a,” “an” and “the” includes plural reference, and the meaning of “in” includes “in” and “on.” Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first,” “second” or “third” can be used to describe various components, signals or the like, which are for distinguishing one component/signal from another one only, and are not intended to, nor should be construed to impose any substantive limitations on the components, signals or the like.

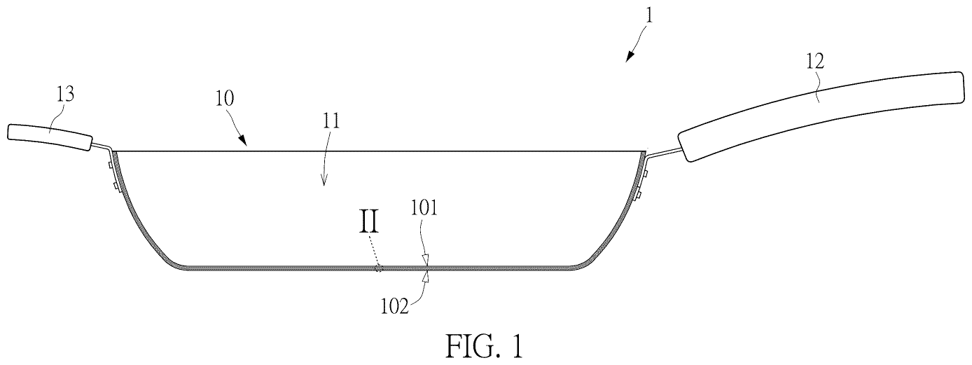

Referring to FIG. 1, an embodiment of the present disclosure provides a composite titanium cookware and method for producing the same. For the ease of illustration, the specification first describes the structure of the composite titanium cookware 1 and then describes the method for producing the composite titanium cookware 1.

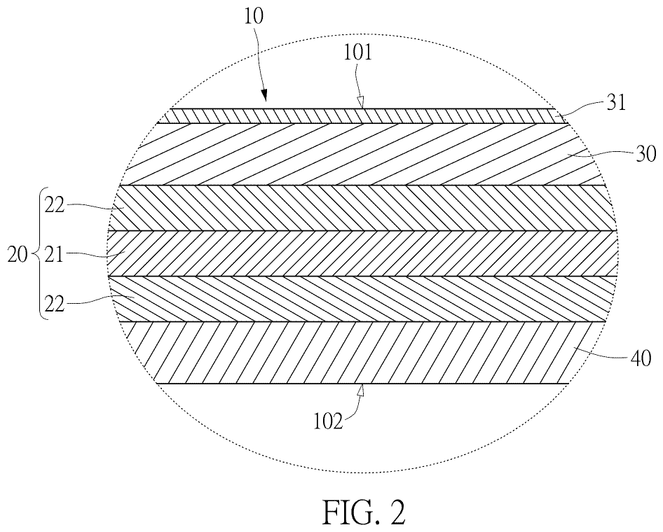

As shown in to FIG. 1 and FIG. 2, the composite titanium cookware 1 of the present disclosure includes a multi-layered cookware body 10 that defines an inner surface 101 and an outer surface 102. The multi-layered cookware body 10 is recessed toward the inner surface 101 to form a recessed space 11, the multi-layered cookware body 10 includes a grip 12 disposed at one side thereof, and the multi-layered cookware body 10 includes a handle 13 disposed at one side thereof opposite to the grip 12 to be held by a user.

The multi-layered cookware body 10 includes an aluminum alloy sandwich structure 20, a titanium layer 30 arranged at the inner surface 101 of the multi-layered cookware body 10, and a stainless steel layer 40 arranged at the outer surface 102 of the multi-layered cookware body 10, and the aluminum alloy sandwich structure 20 is arranged between the titanium alloy layer 30 and the stainless steel layer 40. In a preferable embodiment of the present disclosure, a thickness of a first aluminum alloy material layer 21 and two aluminum alloy material layers 22 can be between 0.2 mm and 0.6 mm.

As shown in FIG. 2 to FIG. 4, the aluminum alloy sandwich structure 20 includes the first aluminum alloy material layer 21 and the two second aluminum alloy material layers 22 pasted at two opposite side surfaces of the first aluminum alloy material layer 21. The first aluminum alloy material layer 21 and the second aluminum alloy material layers 22 are made of different aluminum alloy materials, and the first aluminum alloy material layer 21 and the second aluminum alloy layers 22 are combined in an atomic diffusion bonding manner. Preferably, in the aluminum alloy sandwich structure 20, the first aluminum alloy material layer 21 is made of an aluminum alloy material having a tensile strength greater than that of the second aluminum alloy material layers 22. In an applicable embodiment of the present disclosure, the first aluminum alloy material layer 21 can be made of 3003 aluminum alloy, and the second aluminum alloy materials 22 can be made of 1050 aluminum alloy material.

Since the first aluminum alloy material layer 21 has a relatively high tensile strength, the aluminum alloy sandwich structure 20 has a sufficient strength, so as to prevent the aluminum alloy sandwich structure 20 from irregular deformation during plastic processing. Since a tensile strength of each of the second aluminum alloy material layers 22 is less than the tensile strength of the first aluminum alloy material layer 21, each of the second aluminum alloy material layers 22 has a relatively high ductility, such that the surfaces of the second aluminum alloy material layers 22 can be tightly combined with the titanium layer 30 and the stainless steel layer 40.

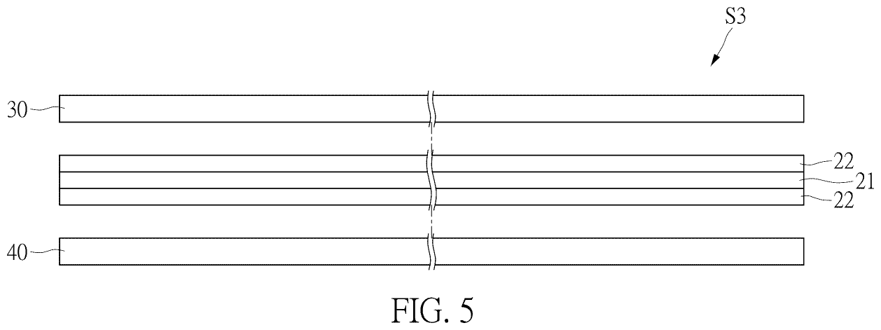

As shown in FIG. 2 and FIG. 5, the titanium layer 30 and the stainless steel 40 are respectively disposed at an inner side surface and an outer side surface of the aluminum alloy sandwich structure 20, and the titanium layer 30 and the stainless steel layer 40 are combined at two surfaces of the two second aluminum alloy material layers 22 of the aluminum alloy sandwich structure 20 in the atomic diffusion bonding manner. Preferably, the titanium layer 30 can be made of a pure titanium board, and a thickness of the titanium layer 30 can be between 0.2 mm and 0.6 mm.

In addition, in the present embodiment, the titanium layer 30 further includes an anti-stick layer 30 formed at a surface thereof, the anti-stick layer 31 can be made of titanium oxides such as titanium oxide (TiOx), titanium nitride (TiN), or titanium oxynitride (TiNxOy), and a thickness of the anti-stick layer 31 is greater than 3μm. More specifically, the anti-stick layer 31 is formed at the surface of the titanium layer 30 through thermal oxidation, electrochemical oxidation, or micro-arc oxidation, such that the surface of the titanium layer 30 is in contact with oxygen atoms, nitrogen atoms, or other working gas atoms and titanium atoms by reacting with oxygen atoms or nitrogen atoms.

It is worth mentioning that, in a preferable embodiment, the titanium layer 30 is oxidized at an alpha phase, such that the titanium atoms at the surface of the titanium layer 30 react with the oxygen atoms or the nitrogen atoms to form a titanium oxide film in a rutile crystal form. Since the titanium oxide film in the rutile crystal form has properties of dense texture, high hardness, and non-toxicity, the surface of the titanium layer 30 is transformed from the original metal surface to a ceramicized titanium oxide film surface. Accordingly, an anti-stick surface is formed, the hardness of the titanium layer 30 is increased, and the titanium layer 30 is not easily worn, oxidized, corroded, and does not easily release toxicity. In addition, since the titanium oxide film can have tight bonding with the titanium atoms at the surface of the titanium layer 30, the anti-stick layer 31 is not easy to peel off and can be used for a long time without being damaged.

The stainless steel layer 40 is combined at another surface of the aluminum alloy sandwich structure 20 away from the titanium layer 30. A thickness of the stainless steel layer 40 is between 0.2 mm and 0.8 mm. Preferably, the stainless steel layer 40 can be made of a magnetic stainless steel material, such that the stainless steel layer 40 has a magnetic conductivity. For example, the stainless steel layer 40 can be made of 400 series stainless steel material (e.g., 430 stainless steel), such that the stainless steel layer 40 has the magnetic conductivity, and the multi-layered cookware body 10 can be used on an induction cooker.

It is worth mentioning that, in the atomic diffusion bonding manner, the surfaces of the metals to be combined are in contact with each other, after being heated and pressurized, the atoms at the surfaces of the metals to be combined mutually diffuse, so that a phase change occurs, and the two metals are combined into a whole. In the atomic diffusion bonding manner, the metals are not necessary to be heated to a liquid melting temperature, or a filling solder is not required, and accordingly, a metal board having a large surface area can be combined surface to surface and not be melted or deformed, and the metal board is stably combined and has excellent strength. Accordingly, the multi-layered cookware body 10 in the present embodiment can be formed by combining multiple metal boards, such that the multi-layered cookware body 10 can have a strength on par with a cookware that is integrally formed by a metal board.

In addition, since the atoms of aluminum, titanium, and stainless steel can easily diffuse to form an eutectic structure, and a middle layer of the multi-layered cookware body 10 in the present disclosure is made of the aluminum alloy sandwich structure 20, the titanium layer 30 and the stainless steel 40 can be combined with each other through the aluminum alloy sandwich structure 20 that has affinity with titanium and stainless steel, thereby lowering the difficulty of combining the titanium layer 30 and the stainless steel layer 40.

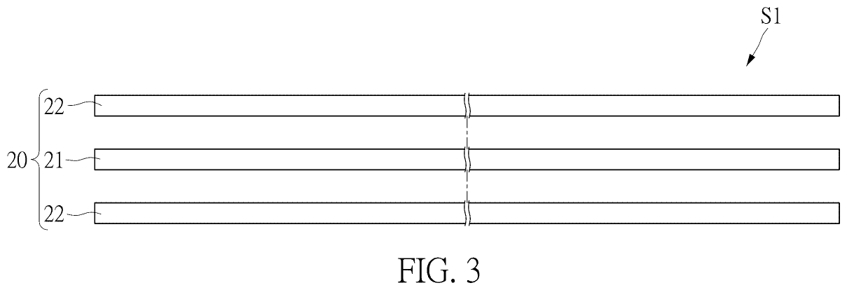

The producing method of the present disclosure is described as follows. As shown in FIG. 10 and FIG. 3 to FIG. 9, the method for producing the composite titanium cookware 1 primarily includes a metal board preparing process S1, a first diffusion bonding process S2, a second diffusion bonding process S3, a cookware forming process S4, a trimming process S5, and a surface treating process S6 that is selectively implemented.

The metal board preparing process S1 is implemented by cutting an aluminum alloy board, a titanium board, and a stainless steel into the first aluminum alloy material layer 21, the second aluminum alloy material layers 22, the titanium layer 30, and the stainless steel layer 40 according to predetermined sizes. The first aluminum alloy material layer 21, the second aluminum alloy material layers 22, the titanium layer 30, and the stainless steel layer 40 are surface treated, a plurality of combined surfaces of the first aluminum alloy material layer 21, the second aluminum alloy material layers 22, the titanium layer 30, and the stainless steel layer 40 are polished or grinded, such that the combined surfaces of the first aluminum alloy material layer 21, the second aluminum alloy material layers 22, the titanium layer 30, and the stainless steel layer 40 are flat. Afterwards, the surfaces of the first aluminum alloy material layer 21, the second aluminum alloy material layers 22, the titanium layer 30, and the stainless steel layer 40 are washed to remove oxides and impurities thereon.

Through the metal board preparing process S1, the first aluminum alloy material layer 21, the second aluminum alloy material layers 22, the titanium layer 30, the stainless steel layer 40 have flat surfaces and do not have oxides and impurities remaining, and each of the metal layers can be combined through the atomic diffusion bonding manner.

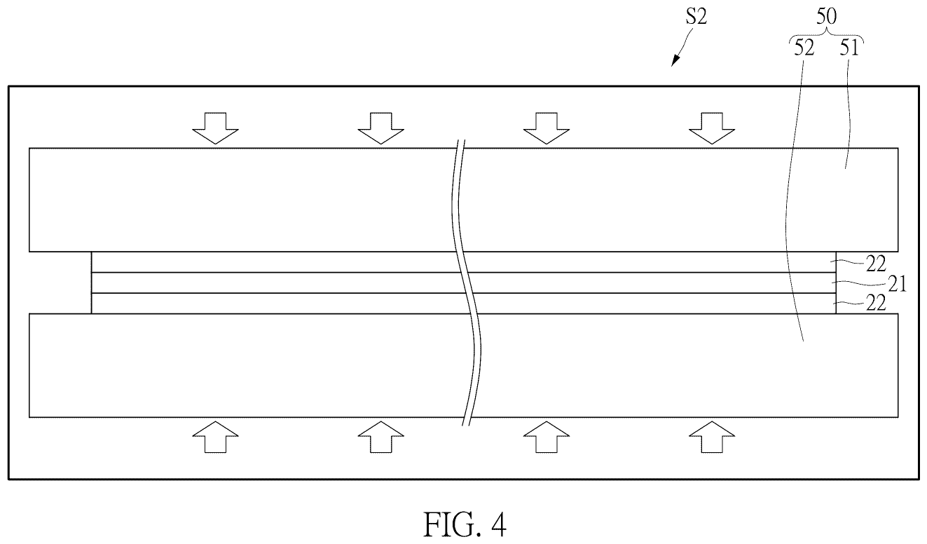

As shown in FIG. 3 and FIG. 4, in the first diffusion bonding process S2, the two aluminum alloy material layers 22 that are surface treated and cleaned are laminated at two sides of the first aluminum alloy material layer 21, and in a vacuum environment or an inert gas environment, the laminated two second aluminum alloy material layers 22 and the first aluminum alloy material layer 21 are heated and pressurized, such that the two second aluminum alloy material layer 22 and the first aluminum alloy material layer 21 are combined into the aluminum alloy sandwich structure 20.

As shown in FIG. 4, in the first diffusion bonding process S2 of one embodiment, the second aluminum alloy material layers 22 and the first aluminum alloy material layer 21 are laminated through a first heating and pressing device 50, and then, after being heated, the contact surfaces of the second aluminum alloy material layers 22 and the first aluminum alloy material layer 21 are combined through diffusion. In the present embodiment, the first heating and pressing device 50 is disposed in an enclosed chamber, and the enclosed chamber is in a vacuum state or filled with an inert gas (e.g., argon), so as to prevent the second aluminum alloy material layers 22 and the first aluminum alloy material layer 21 from oxidation during combination through diffusion.

The first heating and pressing device 50 includes a first pressing member 51 and a second pressing member 52 that are in flat shapes, the first pressing member 51 and the second pressing member 52 can press the two aluminum alloy material layers 22 from outer sides of the aluminum alloy sandwich structure 20 and can heat the second aluminum alloy material layers 22 and the first aluminum alloy material 21 at the same time, such that atomic diffusion occurs at the combined surfaces of the second aluminum alloy material layers 22 and the first aluminum alloy material layer 21, and the second aluminum alloy material layers 22 and the first aluminum alloy material layer 21 are combined.

In a preferable embodiment of the present disclosure, in the first diffusion bonding process S2, the second aluminum alloy material layers 22 and the first aluminum alloy layer 21 are pressurized at static pressure of between 10 Mpa and 50 Mpa and heated at a temperature of 200° C. and 600° C. for 10 minutes to 60 minutes in a vacuum heating oven, such that the second aluminum alloy material layers 22 and the first aluminum alloy material layer 21 are combined to form the aluminum alloy sandwich structure 20.

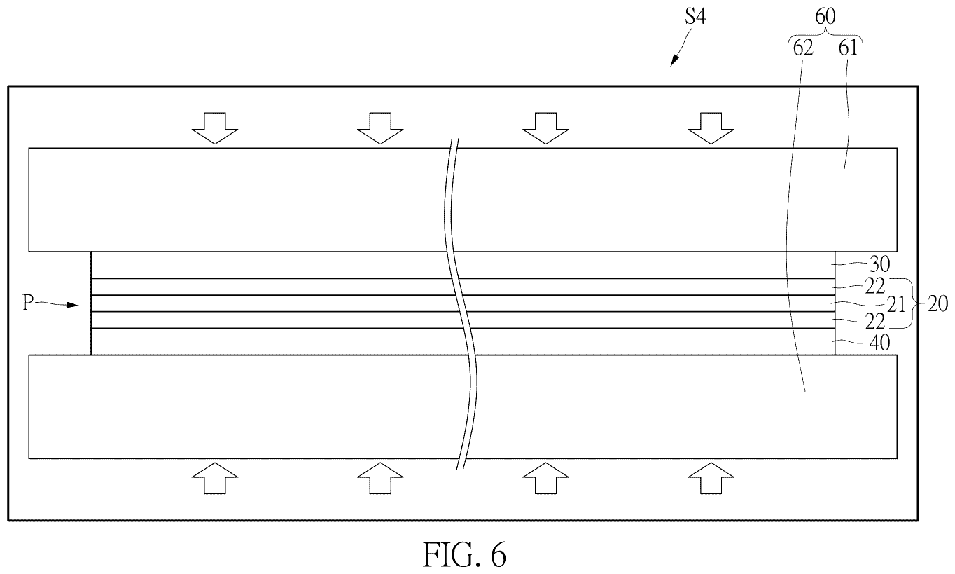

As shown in FIG. 5 and FIG. 6, in the second diffusion bonding process S3, the titanium layer 30 and the stainless steel layer 40 are placed at two side surfaces of the aluminum alloy sandwich structure 20, and then the titanium layer 30, the stainless steel layer 40, and the aluminum alloy sandwich structure 20 are heated in a vacuum environment or in an environment filled with an inert gas, such that the titanium layer 30, the stainless steel layer 40, and the aluminum alloy sandwich structure 20 are combined through diffusion, so as to form a multi-layered composite material P for producing the multi-layered cookware body 10.

As shown in FIG. 6, in the second diffusion bonding process S3 of one embodiment the titanium layer 30, the stainless steel layer 40, and the aluminum alloy sandwich structure 20 are laminated through a second heating and pressing device 60, and the titanium 30, the stainless steel layer 40, and the aluminum alloy sandwich structure 20 are heated to be combined together through diffusion to form the multi-layered composite material P. In the present embodiment, the second heating and pressing device 60 is disposed in an enclosed chamber, the enclosed chamber is in a vacuum state or filled with an inert gas (e.g., argon), so as to prevent the second aluminum alloy material layers 22 and the first aluminum alloy material layer 21 from oxidation during diffusion and combination.

The second heating and pressing device 60 includes a first pressing member 61 and a second pressing member 62 that are in flat shapes, the first pressing member 61 and the second pressing member 62 can press the titanium layer 30 and the stainless steel layer 40 from outer sides thereof and can heat the titanium layer 30, the stainless steel layer 40, and the aluminum alloy sandwich structure 20 at the same time, such that atomic diffusion occurs at the combined surfaces of the titanium layer 30, the stainless steel layer 40, and the aluminum alloy sandwich structure 20, and the titanium layer 30, the stainless steel layer 40, and the aluminum alloy sandwich structure 20 are combined to form the multi-layered composite material P that is in a flat shape.

Preferably, in the second diffusion bonding process S3, the titanium layer 30, the aluminum alloy sandwich structure 20, and the stainless steel layer 40 are pressurized at a pressure of between 10 Mpa and 50 Mpa and heated at a temperature of between 400° C. and 750° C. in a vacuum heating oven for 10 minutes to 60 minutes, such that the titanium layer 30, the aluminum alloy sandwich structure 20, and the stainless steel layer 40 are combined through diffusion to form the aluminum alloy sandwich structure.

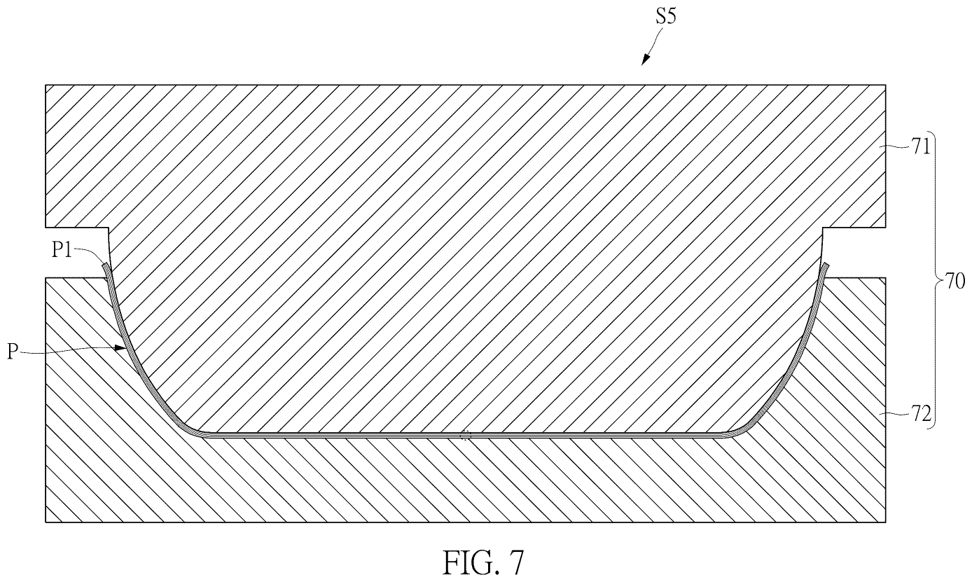

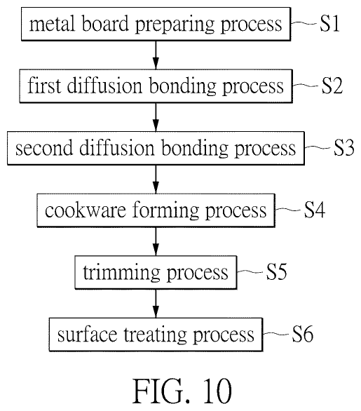

As shown in FIG. 10 and FIG. 7, in the cookware forming process S4, the multi-layered composite material P are plastically processed to form into the multi-layered cookware body 10.

Referring to the embodiment shown in FIG. 7, the multi-layered composite material P forms into the multi-layered cookware body 10 through a forming mold 70. The forming mold 70 includes an upper mold 71 and a bottom mold 72 that correspond to each other, the upper mold 71 and the bottom mold 72 respectively includes a mold core and a mold cavity having complementary shapes, and the forming mold 70 can be used to form the multi-layered composite material P that is in the flat shape into the multi-layered cookware body 10 that has the recessed space 11.

It is worth mentioning that, in the method shown in FIG. 7, the forming mold 70 is used to form the multi-layered cookware body 10, but the present disclosure is not limited thereto. For example, in the cookware forming process S4, the multi-layered cookware body 10 can be formed in spin forming manner, a pressure forming manner, or an explosion forming manner. In addition, the cookware forming process S4 can be implemented more than once. For example, if the shape of the multi-layered cookware body 10 cannot be formed in a single time, the cookware forming process S4 can be implemented for several times, such that the multi-layered composite material P is processed in stages to form the multi-layered cookware body 10.

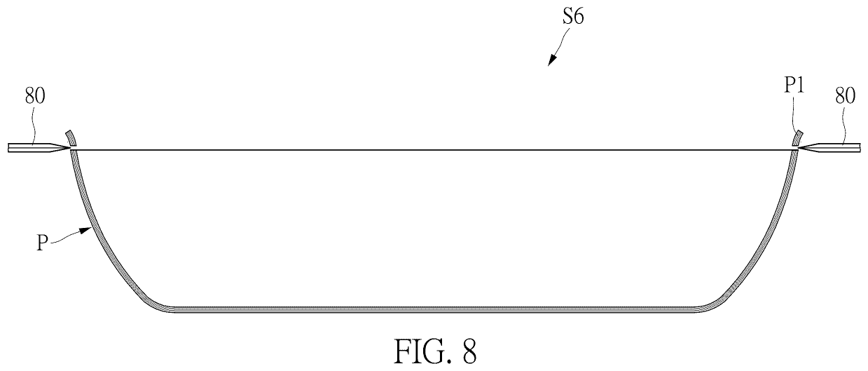

Referring to FIG. 10 and FIG. 8, in the trimming process S5, an excess material P1 at the edges of the formed multi-layered cookware body 10 is cut, and after the excess material P1 is cut, the edge of the multi-layered cookware body 10 is trimmed to remove burrs. As shown in FIG. 8, after the multi-layered composite material P forms into the multi-layered cookware body 10, the multi-layered cookware body 10 has irregular excess material P1 at the edge thereof, and a trimming device 80 is used to cut off the excess material P1 at the edge of the multi-layered cookware body 10. Afterwards, the edge of the trimmed multi-layered cookware body 10 is grinded to remove the burrs, such that the edge of the multi-layered cookware body 10 is flat, or the edge is in an arced shape or has a chamfer.

After the multi-layered cookware body 10 is formed and trimmed, a surface treating process S6 can be selectively implemented. In the surface treating process S6, the surface of the titanium layer 30 at an inner surface of the multi-layered cookware body 10 is oxidized, so as to form the anti-stick layer 31 at the surface of the titanium layer 30. In an applicable embodiment of the present disclosure, the surface of the titanium layer reacts with oxygen atoms or nitrogen atom to forms a titanium oxide film, a titanium nitride film, or a titanium oxynitride film through thermal oxidation, micro-arc oxidation, or electrochemical oxidation, so as to form an anti-stick layer at the surface of the titanium layer.

Through the above-mentioned processes, the prepared multi-layered cookware body 10 can be mounted with other assemblies (e.g., a grip 12 and a handle 13), so as to form the composite titanium cookware 1 of the present disclosure.

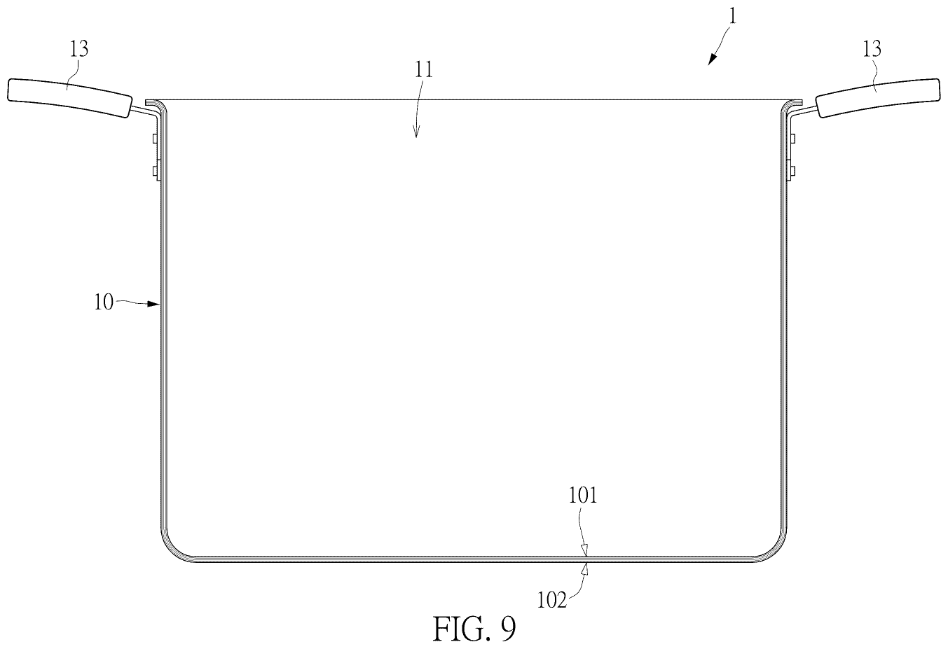

In addition, in the embodiment shown in FIG. 1 to FIG. 8, the composite titanium cookware 1 is disclosed in a shape of a wok or a frying pan, but the present disclosure is not limited thereto. The composite titanium cookware 1 of the present disclosure can be in a shape of other cookware. In the embodiment shown in FIG. 9, the composite titanium cookware 1 is a stockpot, and accordingly, the multi-layered cookware body 10 of the composite titanium cookware 1 has a shape of a cylindrical container with considerable depth.

### Beneficial Effects of the Embodiment

In conclusion, in the present disclosure, the aluminum alloy sandwich structure is disposed between the titanium layer and the stainless steel layer, the titanium layer and the stainless steel layer are combined with the aluminum alloy sandwich structure through diffusion, so as to overcome the difficulty of combining titanium and stainless steel in a conventional method for producing a cookware. In addition, since each metal layer of the multi-layered cookware body is combined in the atomic diffusion bonding manner, each metal layer can easily peel off, and the multi-layered cookware body has a strength on par with a cookware that is integrally-formed by a metal board.

In addition, the aluminum alloy sandwich structure of the present disclosure is made of the first aluminum alloy material layer and two second aluminum alloy material layers combined at two sides of the first aluminum alloy material layer through diffusion, the tensile strength of the first aluminum alloy material layer is greater than the tensile strength of each of the second aluminum alloy material layer, and accordingly, the aluminum alloy sandwich structure has a considerable strength, each of the second aluminum alloy material layers have a better ductility and is prone to be in tight contact with the titanium layer and the stainless steel layer.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A composite titanium cookware, comprising:
a multi-layered cookware body including a titanium layer arranged at an inner surface of the multi-layered cookware body, a stainless steel layer arranged at an outer surface of the multi-layered cookware body, and an aluminum alloy sandwich structure arranged between the titanium layer and the stainless steel layer;
wherein the aluminum alloy sandwich structure includes a first aluminum alloy material layer and two second aluminum alloy material layers arranged at two opposite side surfaces of the first aluminum alloy material layer, wherein a tensile strength of the first aluminum alloy material layer is greater than a tensile strength of each of the second aluminum alloy material layers;
wherein the first aluminum alloy material layer and the second aluminum alloy material layers are combined in an atomic diffusion bonding manner;
wherein, after the first aluminum alloy material layer and the second aluminum alloy material layers of the aluminum alloy sandwich structure are combined in the atomic diffusion bonding manner, the titanium layer and the stainless steel layer are combined with two side surfaces of the aluminum alloy sandwich structure through the atomic diffusion bonding manner;
wherein, after the aluminum alloy sandwich structure, the titanium layer, and the stainless steel layer are combined to form a multi-layered composite material that is in a flat shape, and the multi-layered composite material is formed into the composite titanium cookware in a plastic processing manner.

2. The composite titanium cookware according to claim 1, wherein the first aluminum alloy material layer is made of 3003 aluminum alloy, and each of the second aluminum alloy material layers is made of 1050 aluminum alloy.

3. The composite titanium cookware according to claim 1, wherein the titanium layer has an anti-stick layer formed at a surface thereof, and the anti-stick layer is at least one of a titanium oxide film, a titanium nitride film, and a titanium oxynitride film formed at the surface of the titanium layer through thermal oxidation, electrochemical oxidation, or micro-arc oxidation.

4. The composite titanium cookware according to claim 1, wherein stainless steel layer is made of a magnetic stainless steel material.
